(19) United States
(12) Patent Application Publication
(10) Pub. No.: US 2024/0395525 A1
(43) Pub. Date: Nov. 28, 2024

(54) THREE-DIMENSIONAL PRINTED NANOSPRAY INTERFACE FOR MASS SPECTROMETRY

(71) Applicant: AGILENT TECHNOLOGIES, INC., Santa Clara, CA (US)

(72) Inventors: Michael KNIERMAN, Santa Clara, CA (US); Stephen ZANON, Santa Clara, CA (US)

(73) Assignee: AGILENT TECHNOLOGIES, INC., Santa Clara, CA (US)

(21) Appl. No.: 18/322,251

(22) Filed: May 23, 2023

(51) Int. Cl. H01J 49/04; B33Y 80/00

(52) U.S. Cl. CPC H01J 49/0404; B33Y 80/00

(57) ABSTRACT

In some examples, a three-dimensional printed nanospray interface for mass spectrometry may include a body including a sheath inlet connected to a sheath outlet for passage of sheath liquid to an emitter. The emitter may include a sidewall including a stepped texture on an inner surface of the sidewall.

### BACKGROUND

With respect to nanospray-mass spectrometry (MS), the nanospray interface may utilize an electric field to generate an electrospray ionization source. MS may represent a technique to identify chemical species based on their mass-to-charge ratio. Thus, a nanospray electrospray source may combine ion generation with MS that includes measurement of a mass-to-charge ratio of ions. nanospray MS, an emitter may eject ions towards a mass spectrometer inlet of a mass spectrometer to thus provide molecular mass information.

### BRIEF DESCRIPTION OF DRAWINGS

Features of the present disclosure are illustrated by way of example and not limited in the following figure(s), in which like numerals indicate like elements, in which:

FIG. 1A illustrates an isometric view of a first embodiment of a three-dimensional printed nanospray interface, in accordance with an example of the present disclosure;

FIG. 1B illustrates an isometric cross-sectional view of the first embodiment of the three-dimensional printed nanospray interface of FIG. 1A, taken along section-line A-A of FIG. 1A, in accordance with an example of the present disclosure;

FIG. 2 illustrates front, top, side, and sectional views (taken along section-line B-B) of a second embodiment of a three-dimensional printed nanospray interface, in accordance with an example of the present disclosure;

FIG. 3 illustrates an isometric view of a nanospray-mass spectrometry holder for the three-dimensional printed nanospray interface of FIG. 2, in accordance with an example of the present disclosure;

FIG. 4 illustrates a diagrammatic cutout and isometric views of a third embodiment of a three-dimensional printed nanospray interface, in accordance with an example of the present disclosure;

FIG. 5 illustrates details of an emitter of the first, second, and third embodiments of the three-dimensional printed nanospray interface, in accordance with an example of the present disclosure;

FIG. 6 illustrates further details of the emitter of the first, second, and third embodiments of the three-dimensional printed nanospray interface, in accordance with an example of the present disclosure;

FIG. 7 illustrates a capillary and tapered capillary tubing of the first, second, and third embodiments of the three-dimensional printed nanospray interface, in accordance with an example of the present disclosure;

FIG. 8 illustrates a chevron configuration of an emitter tip of a fourth embodiment of a three-dimensional printed nanospray interface, in accordance with an example of the present disclosure;

FIGS. 9A and 9B illustrate cutout views of the chevron configuration of the emitter tip of the fourth embodiment of the three-dimensional printed nanospray interface, with and without a flowback edge, in accordance with an example of the present disclosure;

FIG. 10 illustrates a front and sectional views (taken along section-line C-C) of the chevron configuration of the emitter tip of the fourth embodiment of the three-dimensional printed nanospray interface, in accordance with an example of the present disclosure;

FIG. 11 illustrates a tapered configuration of an emitter tip of a fifth embodiment of a three-dimensional printed nanospray interface, in accordance with an example of the present disclosure;

FIG. 12 illustrates an emitter tip including V-shaped protrusions for a sixth embodiment of a three-dimensional printed nanospray interface, in accordance with an example of the present disclosure;

FIG. 13 illustrates a seventh embodiment of a three-dimensional printed nanospray interface including multiple spray tips for reagents, in accordance with an example of the present disclosure;

FIG. 14 illustrates isometric views of tip geometry for one or more of the three-dimensional printed nanospray interfaces as disclosed herein, in accordance with an example of the present disclosure;

FIG. 15 illustrates an eighth embodiment of a three-dimensional printed nanospray interface including flow contacts and associated internal tip patterns, in accordance with an example of the present disclosure;

FIG. 16 illustrates a ninth embodiment of a three-dimensional printed nanospray interface including an internal flow restrictor with an acrylic flush channel, in accordance with an example of the present disclosure;

FIG. 17 illustrates a tenth embodiment of a three-dimensional printed nanospray interface including a nanospray tip with an illumination channel to make the spray from the tip visible to a camera, in accordance with an example of the present disclosure;

FIG. 18 illustrates an eleventh embodiment of a three-dimensional printed nanospray interface including a nanospray tip with an illumination channel to make the spray from the tip visible to a camera, in accordance with an example of the present disclosure;

FIG. 19 illustrates a twelfth embodiment of a three-dimensional printed nanospray interface including a sheath gas to assist in spray formation, in accordance with an example of the present disclosure;

FIG. 20 illustrates a thirteenth embodiment of a three-dimensional printed nanospray interface including tip section views and sheath gas integrated into nanospray tip geometry, in accordance with an example of the present disclosure;

FIG. 21 illustrates further details applicable to embodiments such as the eighth embodiment of the three-dimensional printed nanospray interface of FIG. 15, the thirteenth embodiment of the three-dimensional printed nanospray interface of FIG. 20, and other embodiments, in accordance with an example of the present disclosure;

FIGS. 22 and 23 illustrate examples of an installation of a three-dimensional printed nanospray interface, in accordance with an example of the present disclosure;

FIG. 24 illustrates various isometric and cutout views of a chip holder for a three-dimensional printed nanospray interface, in accordance with an example of the present disclosure;

FIG. 25 illustrates various isometric and cutout views of a tip integrated into a three-dimensional printed nanospray interface, in accordance with an example of the present disclosure; and

FIG. 26 illustrates an assembly and views of emitter tip geometry for a three-dimensional printed nanospray interface, in accordance with an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, and the term “including” means including but not limited to. The term “based on” means based at least in part on.

Emitters that are used for nanospray-mass spectrometry (MS) may be formed, for example, by utilizing pulled glass capillaries or tubes that are formed with a heated system. In some cases, a size and/or geometric shapes that may be achieved for such emitters may be restricted due to constrains associated with such emitter forming techniques.

In order to address at least the aforementioned restrictions, a three-dimensional printed nanospray interface for mass spectrometry (hereinafter also referred to as “nanospray interface” or “nanospray interface for mass spectrometry”) is disclosed herein. The nanospray interface disclosed herein may be formed, for example, by three-dimensional (3D) resin printing, or other types of 3D printing techniques. The 3D resin printing may be utilized to print the nanospray interface at voxel sizes on the order of 2 μm. The nanospray interface may include a body including a sheath inlet connected to a sheath outlet for passage of sheath liquid to an emitter. The emitter may include a sidewall including a stepped texture on an inner surface of the sidewall. The nanospray interface may be formed of a ultra-violet (UV) curable material, and may be transparent or formed of an opaque material.

For the nanospray interface described above, the sheath inlet and the sheath outlet may be formed in a generally U-shaped configuration.

For the nanospray interface described above, the nanospray interface may further include a capillary connected to the sheath inlet and the sheath outlet, and a tapered capillary tubing may be disposed in the capillary. The tapered capillary tubing may be axially movable within the capillary.

For the nanospray interface described above, the emitter may include an angled passage leading to an emitter tip. The angled passage may be configured to prevent sheath liquid backflow.

For the nanospray interface described above, the sidewall may include a tapered wall thickness in a direction towards an emitter tip.

For the nanospray interface described above, the emitter may include an emitter tip including a chevron configuration defined by a plurality of angled protrusions.

For the nanospray interface described above, the emitter may include an emitter tip and a flowback edge disposed adjacent to the emitter tip.

For the nanospray interface described above, the emitter may include an emitter tip and a plurality of V-shaped protrusions disposed on a surface of the emitter tip.

For the nanospray interface described above, the emitter may include an emitter tip including an emitter tip exit diameter of approximately 20 μm (e.g., 20±0.5 μm).

For the nanospray interface described above, the emitter may include an approximately 20 μm (e.g., 20±0.5 μm) spray nozzle. In some examples, a 1 mm optical fiber may be coupled to a low power laser light to illuminate the nanospray. In other examples, internal wall structures may support reduction of fluid flow draw and tip longevity in the form of stepped walls, scalloped riblets, or blade riblets, flow straighteners in formations of continuous, aligned staggered, or staggered segmented, flow rotation protrusions similar to ailerons to direct fluid flow in vertexing, helical, and rotational direction, and/or internal sealing protrusions to support micron scale capillary column measuring 360 μm.

For the nanospray interface described above, the nanospray interface may allow coupling to separation techniques such as capillary electrophoresis (CE) and nano high-performance liquid chromatography (HPLC). The nanospray interface may also be used with techniques that include no separation of analytes such as infusion.

For the nanospray interface described above, the emitter may include an emitter tip body including a discreetly routed fluid passage to cool the emitter tip body.

According to examples disclosed herein, a nanospray interface for mass spectrometry may include a body including a sheath inlet connected to a sheath outlet for passage of sheath liquid to an emitter. The sheath inlet and the sheath outlet may be formed, for example, in a generally U-shaped configuration.

For the nanospray interface described above, the nanospray interface may further include an internal passage including micromembrane structures to capture column beads and debris.

For the nanospray interface described above, the emitter may include internal supply passages that include micromembrane structures to support debris containment. Column beads may provide proportionate flow gradient separations to the emitter tip. In order to produce 3D printed ultraviolet (UV) cured details, a cleaning channel that is used to flush out uncured compound may be utilized to support removal of uncured printed material. A service port may be sealed in a second step to reinstate a sealed flow channel.

For the nanospray interface described above, the nanospray interface may further include a plurality of flow straighteners to guide a flow of the sheath liquid and reduce wear.

According to examples disclosed herein, a nanospray interface for mass spectrometry may include a body including a sheath inlet connected to a sheath outlet for passage of sheath liquid to an emitter. The emitter may include an emitter tip. The emitter tip may be offset from a central axis of the nanospray interface, include a non-circular configuration, or include a plurality of V-shaped protrusions disposed on a surface of the emitter tip.

For the nanospray interface described above, the emitter may include a light source angled relative to the emitter tip exit to highlight passage of analyte through the emitter. For example, the emitter may include an optical fiber or low power laser light that is angled on an axial apex to the emitter tip exit to make the nanospray visible. In this regard, the light source may be angled relative to the emitter tip exit to make visible for inspection of spray presence, location, distribution and passage of analyte through the emitter.

For the nanospray interface described above, in one example, the emitter tip may be placed with a close connecting liquid junction ground. Based on the application of a voltage, for example, of 30 kV, the spray potential may be driven.

For the nanospray interface described above, in order to create an inner wall or membrane, after creation of an inner tube wall, uncured UV compound may need to be flushed. In this regard, rinsing holes may be installed to remove uncured UV epoxy with the printed membrane being in place.

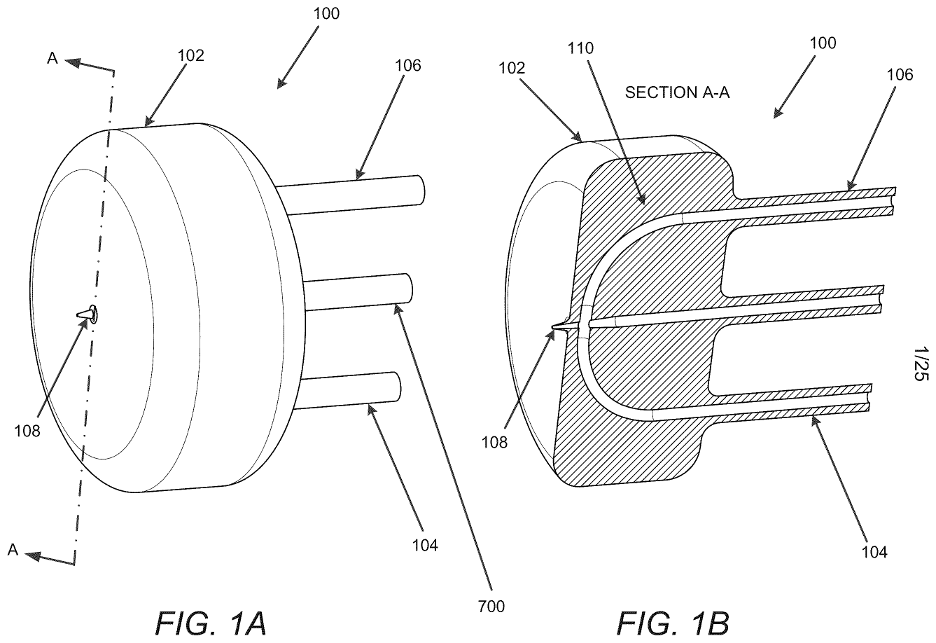

FIG. 1A illustrates an isometric view of a first embodiment of a three-dimensional printed nanospray interface 100, in accordance with an example of the present disclosure. FIG. 1B illustrates an isometric cross-sectional view of the first embodiment of the three-dimensional printed nanospray interface 100, taken along section-line A-A of FIG. 1A, in accordance with an example of the present disclosure.

Referring to FIGS. 1A and 1B, the nanospray interface 100 may include a body 102 including a sheath inlet 104 connected to a sheath outlet 106 for passage of sheath liquid to an emitter 108. As shown in FIG. 1B, the sheath inlet 104 and the sheath outlet 106 may be formed in a generally U-shaped configuration 110.

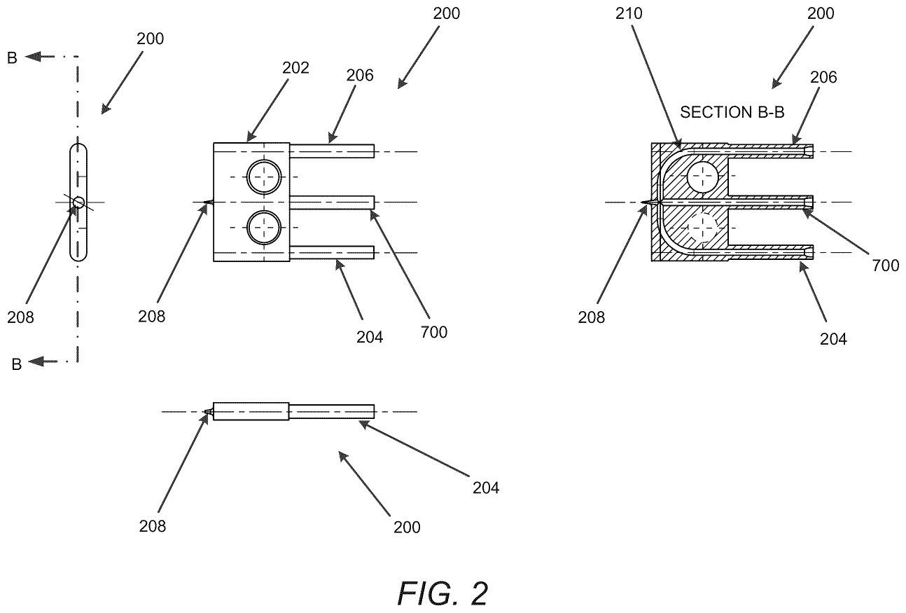

FIG. 2 illustrates front, top, side, and sectional views (taken along section-line B-B) of a second embodiment of a three-dimensional printed nanospray interface 200, in accordance with an example of the present disclosure.

Referring to FIG. 2, the nanospray interface 200 may include a body 202 including a sheath inlet 204 connected to a sheath outlet 206 for passage of sheath liquid to an emitter 208. The sheath inlet 204 and the sheath outlet 206 may be formed in a generally U-shaped configuration 210 as shown. Compared to the nanospray interface 100 that includes the body 102 including a circular configuration, the nanospray interface 200 may include the body 202 including a generally elongated oval configuration.

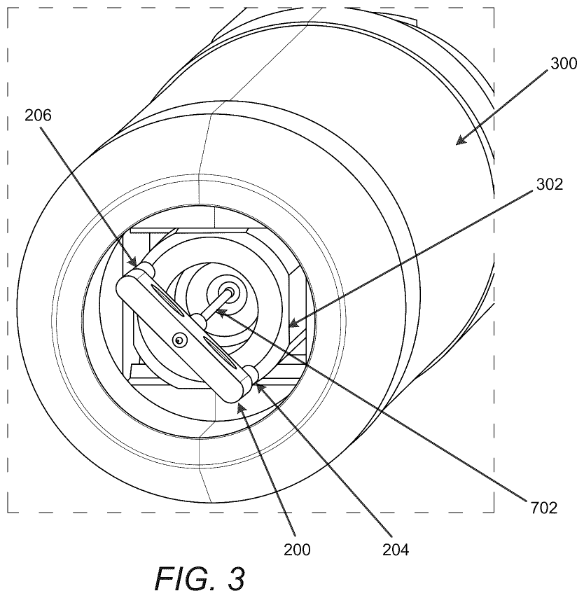

FIG. 3 illustrates an isometric view of a nanospray-mass spectrometry (MS) holder 300 for the three-dimensional printed nanospray interface 200, in accordance with an example of the present disclosure.

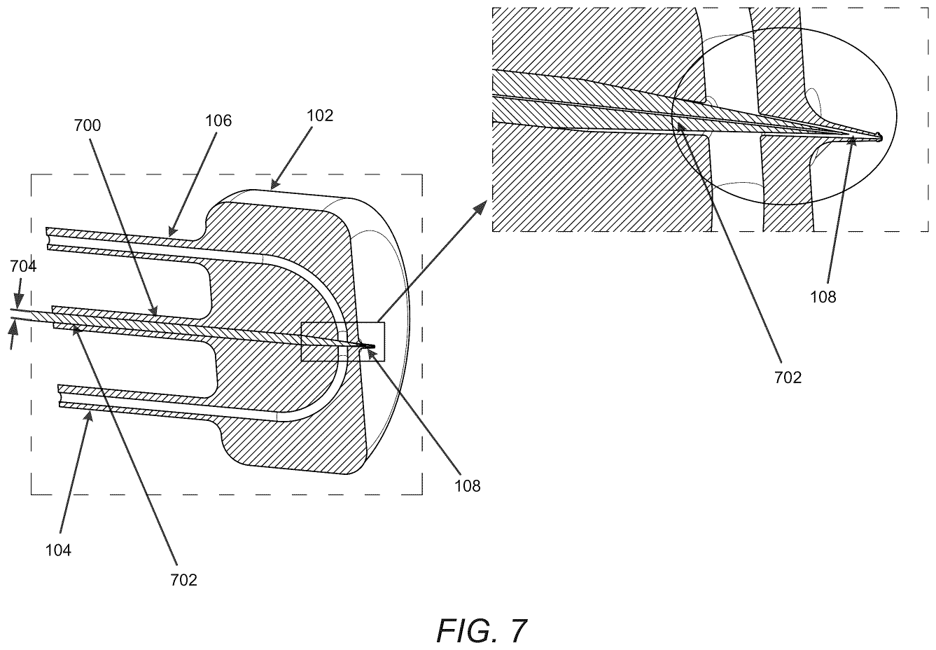

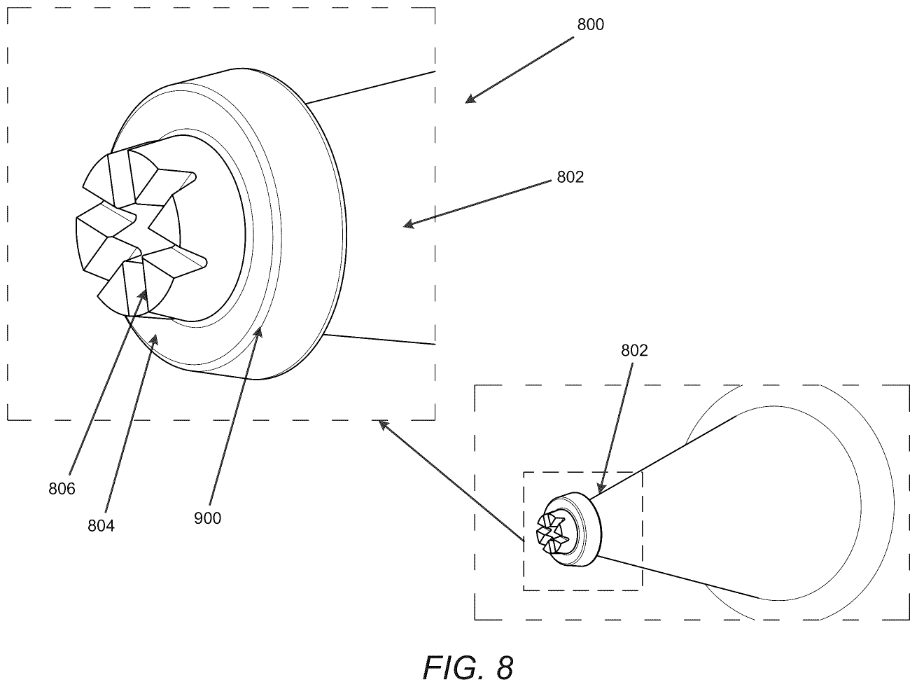

Referring to FIG. 3, the holder 300 for the nanospray interface 200 may include an interface mount 302. The interface mount 302 may include orifices for the sheath inlet 204, the sheath outlet 206, and tapered capillary tubing 702 (e.g., see FIG. 7). The holder 300 may be part of a nanospray-MS assembly (not shown).

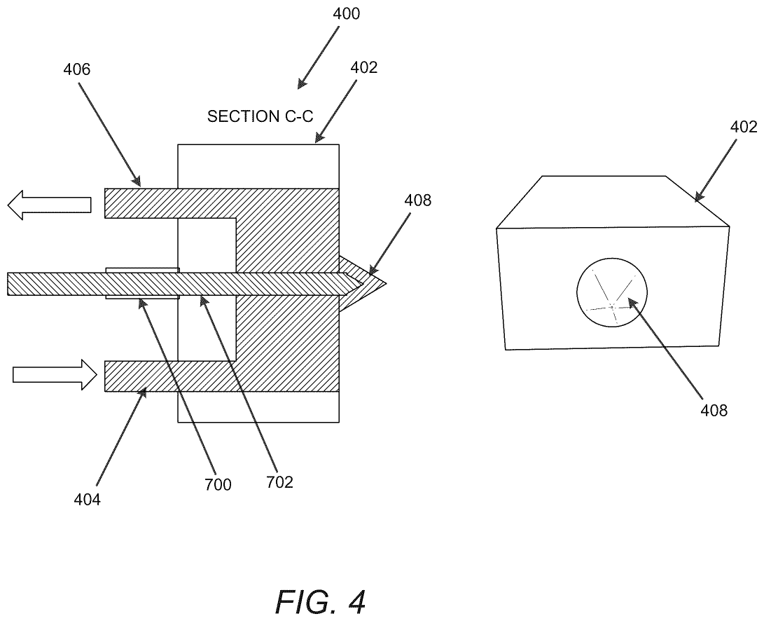

FIG. 4 illustrates a diagrammatic cutout and isometric views of a third embodiment of a three-dimensional printed nanospray interface 400, in accordance with an example of the present disclosure.

Referring to FIG. 4, the nanospray interface 400 may include a body 402 including a sheath inlet 404 connected to a sheath outlet 406 for passage of sheath liquid to an emitter 408. Compared to the nanospray interface 100 that includes the body 102 including a circular configuration, the nanospray interface 400 may include the body 402 including a generally rectangular configuration.

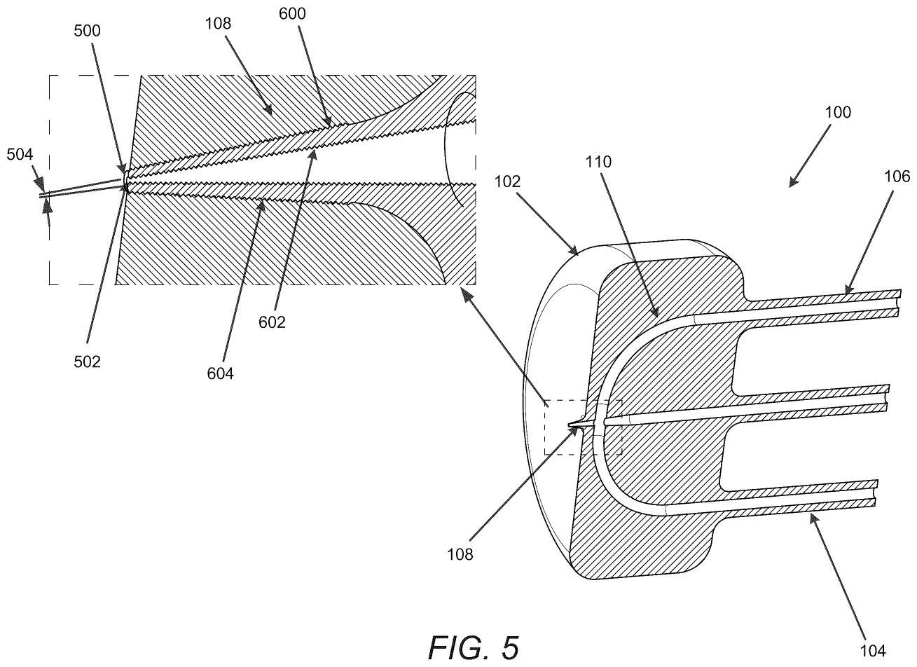

FIG. 5 illustrates details of the emitter of the first, second, and third embodiments of the three-dimensional printed nanospray interface, in accordance with an example of the present disclosure.

Referring to FIG. 5, as discussed above, the nanospray interface 100 (and similarly the interfaces 200 and/or 400) may include the body 102 including the sheath inlet 104 connected to the sheath outlet 106 for passage of sheath liquid to the emitter 108. The emitter 108 (and similarly the emitters 208 and/or 408) may include an emitter tip 500 including an emitter tip exit diameter (of emitter tip exit 502) of less than or equal to 20 μm. Walls of the emitter 108 may include a tapered wall thickness that may include a taper angle 504 of 10º as shown in FIG. 5.

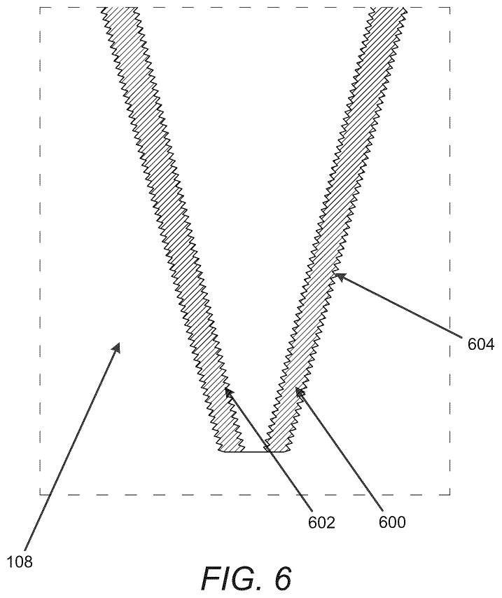

FIG. 6 illustrates further details of the emitter of the first, second, and third embodiments of the three-dimensional printed nanospray interface, in accordance with an example of the present disclosure.

Referring to FIGS. 5 and 6, the emitter 108 (and/or the emitters of 208 and/or 408, respectively, of the nanospray interfaces 200 and/or 400) may include a sidewall 600 including a stepped texture 602 on an inner surface of the sidewall 600. Similarly, the sidewall 600 may include a stepped texture 604 on an outer surface of the sidewall 600. The stepped texture 602 may provide for the capture of droplets of the sheath liquid to facilitate flow of the sheath liquid. In this regard, the droplets that are captured may facilitate flow of the sheath liquid over the captured sheath droplets (e.g., to provide fluid over fluid flow).

FIG. 7 illustrates a capillary and tapered capillary tubing of the first, second, and third embodiments of the three-dimensional printed nanospray interface, in accordance with an example of the present disclosure.

Referring to FIG. 7, the nanospray interfaces 100, 200, and/or 400 may include a capillary 700 connected to the sheath inlet and the sheath outlet. The capillary 700 may include a separation capillary. A tapered capillary tubing 702 may be disposed in the capillary 700. The tapered capillary tubing 702 may be axially movable within the capillary 700 to control passage of analyte to the emitter. For example, the capillary tubing 702 may be retracted in a direction away from the emitter to bypass the analyte through the emitter, and moved in an opposite direction towards the emitter to direct the analyte to the emitter. In the example of FIG. 7, the tapered capillary tubing 702 may include an outer diameter 704 of 360 μm. However, the diameter of the tapered capillary tubing 702 may be increased or decreased as needed, depending, for example, on factors such as a type of the sheath liquid, operation of the nanospray interface, etc.

FIG. 8 illustrates a chevron configuration of an emitter tip of a fourth embodiment of a three-dimensional printed nanospray interface 800, in accordance with an example of the present disclosure.

Referring to FIG. 8, the emitter (e.g., any of the emitters disclosed herein) may include an emitter tip 802 including a chevron configuration 804 defined by a plurality of angled protrusions 806. Thus, in the example of FIG. 8, the emitter tip 802 may include a non-circular configuration (e.g., the chevron configuration 804). The angled protrusions 806 may include triangular protrusions 806 as shown. In the example of FIG. 8, six triangular protrusions are shown. However a number of the triangular protrusions may be increased or decreased to modify an output of the sheath liquid from the emitter tip 802.

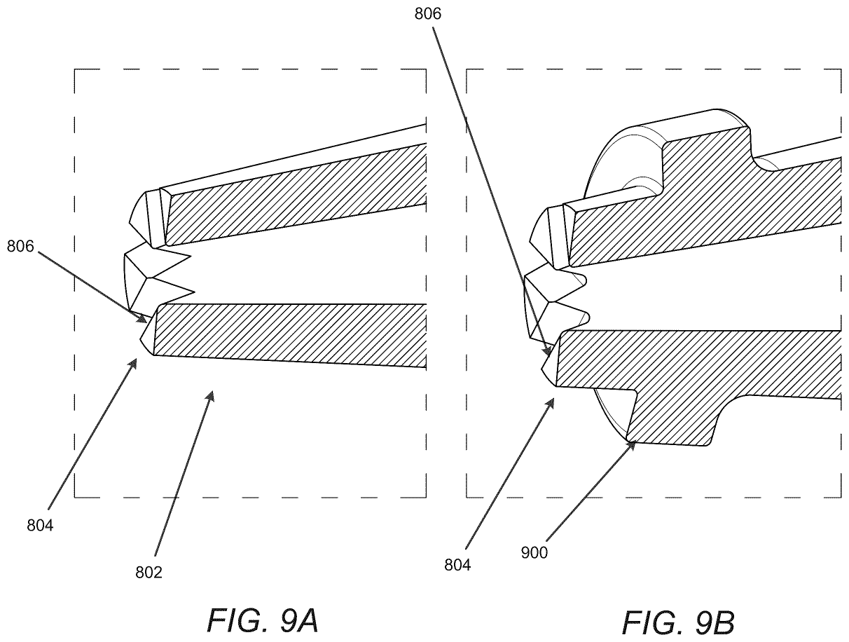

FIGS. 9A and 9B illustrate cutout views of the chevron configuration of the emitter tip of the fourth embodiment of the three-dimensional printed nanospray interface 800, with and without a flowback edge, in accordance with an example of the present disclosure.

Referring to FIG. 9A, in a similar manner as disclosed herein with respect to FIG. 8, the emitter (e.g., any of the emitters disclosed herein) may include the emitter tip 802 including the chevron configuration 804 defined by the plurality of angled protrusions 806. In the example of FIG. 9A, the emitter tip 802 may include a non-circular configuration (e.g., the chevron configuration 804). For the example of FIG. 9B, the emitter may include an emitter tip and a flowback edge 900 disposed adjacent to the emitter tip. The flowback edge 900 may limit flowback of the sheath liquid that is emitted from the emitter tip 802 towards the body of the nanospray interface.

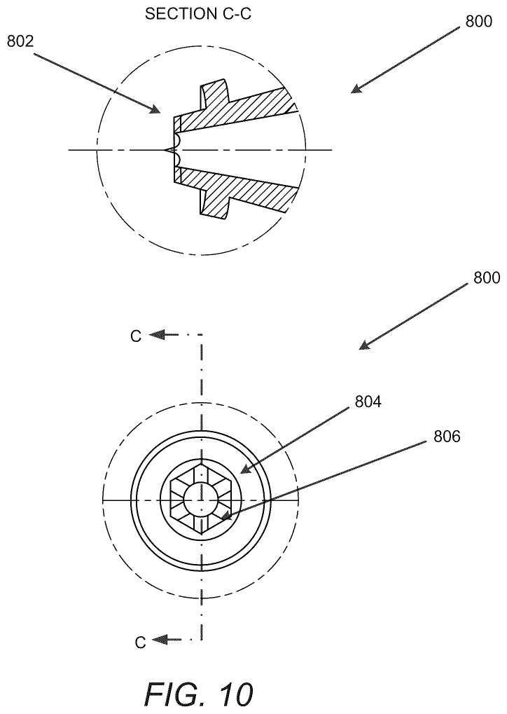

FIG. 10 illustrates a front and sectional views (taken along section-line C-C) of the chevron configuration of the emitter tip of the fourth embodiment of the three-dimensional printed nanospray interface 800, in accordance with an example of the present disclosure.

Referring to FIG. 10, as disclosed herein with respect to FIG. 9B, the emitter may include an emitter tip and the flowback edge 900 disposed adjacent to the emitter tip. The emitter (e.g., any of the emitters disclosed herein) may include the emitter tip 802 including the chevron configuration 804 defined by the plurality of angled protrusions 806. The angled protrusions 806 may include triangular protrusions 806 as shown. In the example of FIG. 10, six triangular protrusions are shown. However a number of the triangular protrusions may be increased or decreased to modify an output of the sheath liquid from the emitter tip 802.

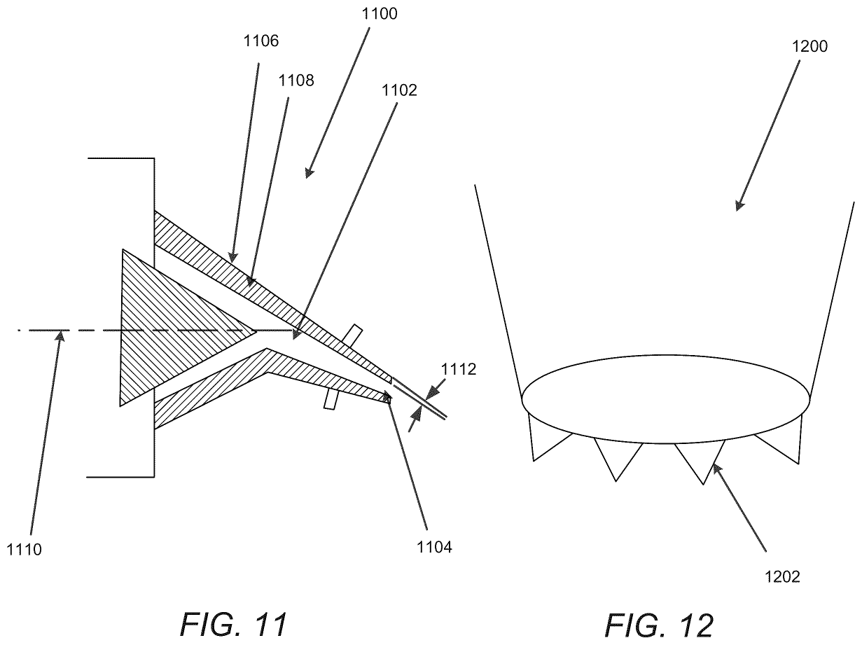

FIG. 11 illustrates a tapered configuration of an emitter tip of a fifth embodiment of a three-dimensional printed nanospray interface 1100, in accordance with an example of the present disclosure.

Referring to FIG. 11, the emitter (e.g., any of the emitters disclosed herein) may include an angled passage 1102 leading to an emitter tip 1104. The angled passage 1102 may be configured to prevent sheath liquid backflow. As shown in FIG. 11, sidewall 1106 (or the sidewall of any of the emitters disclosed herein) may include a tapered wall thickness 1108 that is tapered in a direction towards an emitter tip exit. For example, the tapered wall thickness 1108 may include a taper angle 1112 of 10º as shown in FIG. 11. In the example of FIG. 11, the emitter tip may be offset from a central axis 1110 of the nanospray interface 1100.

FIG. 12 illustrates an emitter tip including V-shaped protrusions for a sixth embodiment of a three-dimensional printed nanospray interface 1200, in accordance with an example of the present disclosure.

Referring to FIG. 12, the emitter (e.g., any of the emitters disclosed herein) may include an emitter tip and a plurality of V-shaped protrusions 1202 disposed on a surface of the emitter tip. The V-shaped protrusions 1202 may modify a flow of sheath liquid exiting the emitter tip. For example, the V-shaped protrusions 1202 may facilitate maintaining of a spray of the sheath liquid.

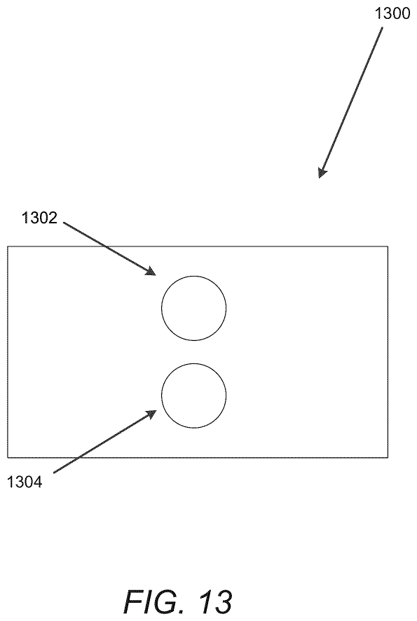

FIG. 13 illustrates a seventh embodiment of a three-dimensional printed nanospray interface 1300 including multiple spray tips for reagents, in accordance with an example of the present disclosure.

Referring to FIG. 13, the nanospray interface 1300 may include a sprayer 1302 and a reagent sprayer 1304. Thus, the nanospray interface 1300 may provide multiple spray tips, with one spray tip (e.g., sprayer 1302) for sheath liquid and another spray tip (e.g., reagent sprayer 1304) for reagents or gas.

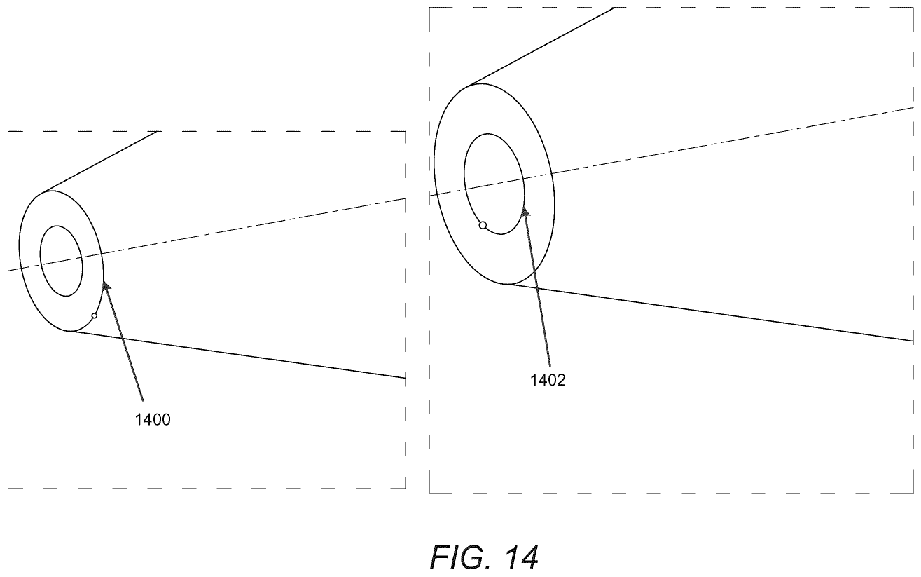

FIG. 14 illustrates isometric views of tip geometry for one or more of the three-dimensional printed nanospray interfaces as disclosed herein, in accordance with an example of the present disclosure.

Referring to FIG. 14, in some examples, the tip geometry for the emitter tip (e.g., for the emitter 108 or other emitters as disclosed herein) may include an external diameter 1400 of approximately 40 μm (e.g., 40±0.5 μm) and an internal diameter 1402 of approximately 20 μm (e.g., 20±0.5 μm).

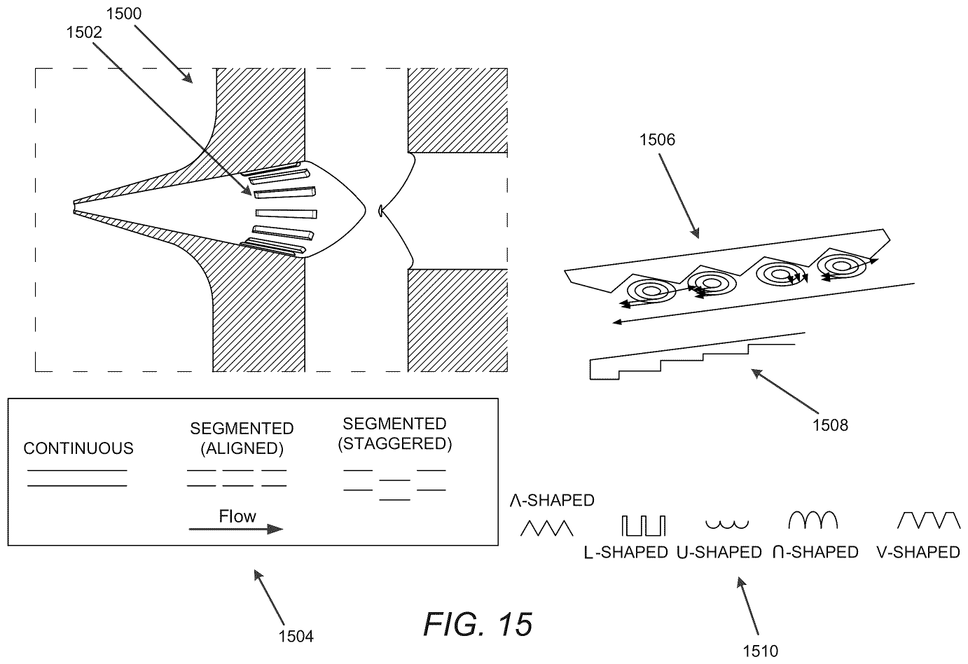

FIG. 15 illustrates an eighth embodiment of a three-dimensional printed nanospray interface including flow contacts and associated internal tip patterns, in accordance with an example of the present disclosure.

Referring to FIG. 15, the nanospray interface may further include a plurality of flow straighteners to guide a flow of the sheath liquid. For example, with respect to flow contacts, an inner surface of emitter tip 1500 may include an inner surface performance enhancing surface roughness (e.g., radially distributed axial pattern 1502). The radially distributed axial pattern 1502 may include flow straighteners to maintain laminar flow, as well as to provide a contact area to keep a tapered capillary tubing wetted. The flow straighteners may include continuous, aligned segmented, and/or staggered segmented patterns as shown at 1504.

At 1506, various internal tip patterns (e.g., the stepped texture as disclosed herein) are shown. The tip patterns may provide for an increase in fluid flow and drag reduction. Examples of tip patterns may include internal stepped riblets at 1508, internal single helix, and other patterns as shown at 1510.

The internal wall structures may thus support reduction of fluid flow draw and tip longevity in the form of stepped walls, scalloped riblets, or blade riblets, flow straighteners in formations of continuous, aligned staggered, or staggered segmented, flow rotation protrusions similar to ailerons to direct fluid flow in vertexing, helical, and rotational direction, and/or internal sealing protrusions to support a micron scale capillary column.

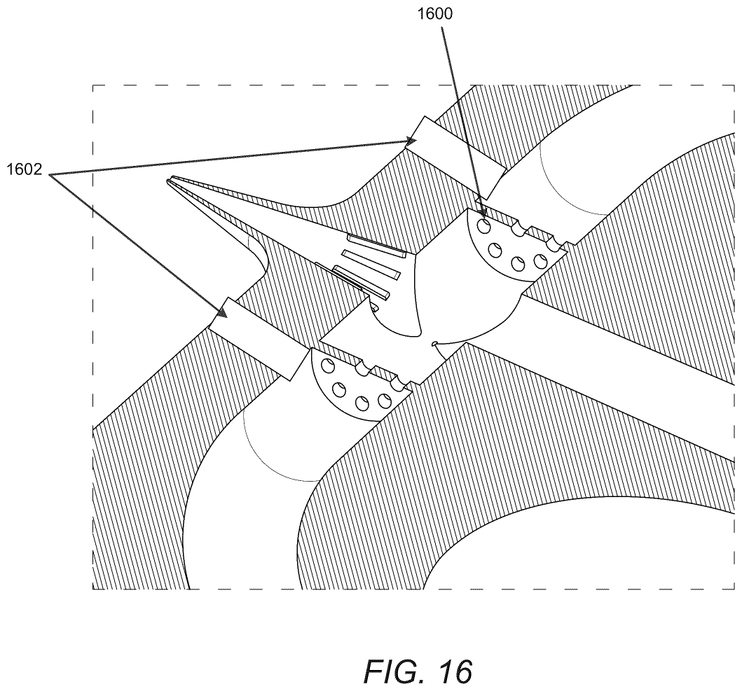

FIG. 16 illustrates a ninth embodiment of a three-dimensional printed nanospray interface including an internal flow restrictor with an acrylic flush channel, in accordance with an example of the present disclosure.

Referring to FIG. 16, the emitter may include internal supply passages that include micromembrane structures (e.g., internal flow restrictor 1600) to support debris containment. Column beads may provide proportionate flow gradient separations to the emitter tip. In order to produce 3D printed ultraviolet (UV) cured details, a cleaning channel 1602 that may be used to flush out uncured compound to thus support removal of uncured printed material. The cleaning channel 1602 may be sealed in a second step to reinstate a sealed flow channel.

In one example, the internal flow restrictor 1600 may include acrylic flush channels 1602. The internal restrictors and flush channels may facilitate removal of residuals of uncured 3D printing fluid. After flushing, the temporary flush channels may be sealed shut with UV curable epoxy, while leaving the restrictor structure.

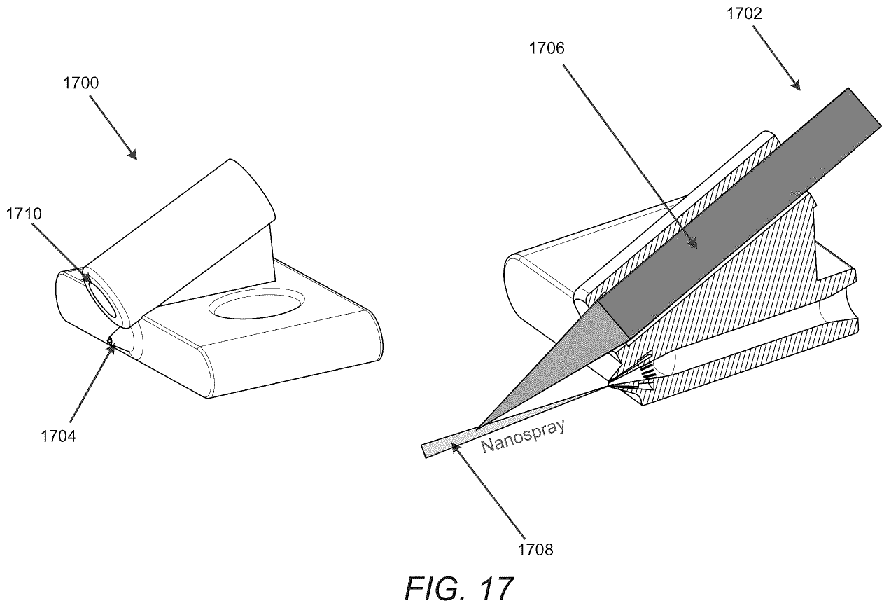

FIG. 17 illustrates a tenth embodiment of a three-dimensional printed nanospray interface including a nanospray tip with an illumination channel to make the spray from the tip visible to a camera, in accordance with an example of the present disclosure.

Referring to FIG. 17, emitter 1700 may include a light source 1702 angled relative to the emitter tip 1704 exit to highlight passage of analyte through the emitter. For example, the emitter 1700 may include an optical fiber or low power laser light 1706 that is angled on an axial apex to the emitter tip exit to make nanospray 1708 visible. In this regard, the emitter 1700 with illumination channel 1710 is shown. The illumination channel 1710 may make the emitter tip 1704 visible.

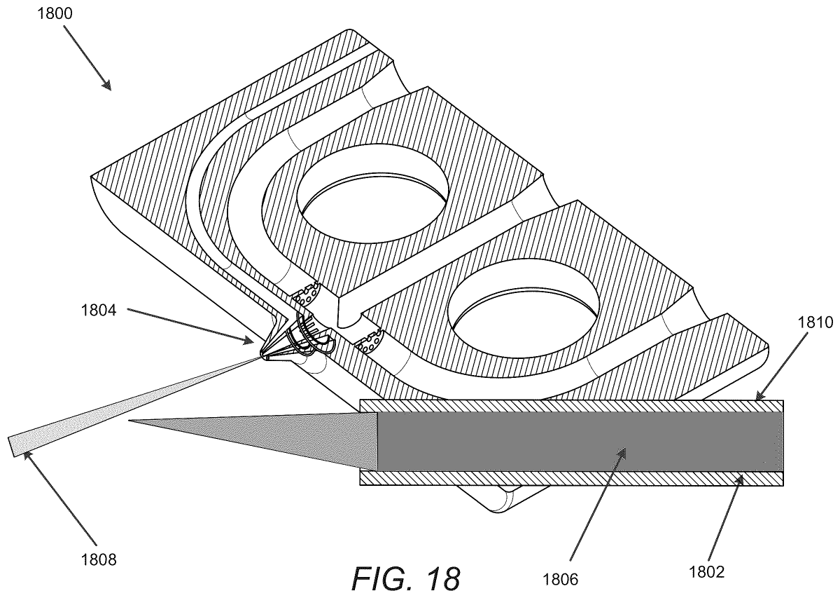

FIG. 18 illustrates an eleventh embodiment of a three-dimensional printed nanospray interface including a nanospray tip with an illumination channel to make the spray from the tip visible to a camera, in accordance with an example of the present disclosure.

Referring to FIG. 18, emitter 1800 may include a light source 1802 angled relative to the emitter tip 1804 exit to highlight passage of analyte through the emitter. For example, the emitter 1800 may include an optical fiber or low power laser light 1806 that is angled on an axial apex to the emitter tip exit to make nanospray 1808 visible. In this regard, the emitter 1800 with illumination channel 1810 is shown. The illumination channel 1810 may make the emitter tip 1804 visible. Compared to the example of FIG. 18, for emitter 1800, the illumination channel 1810 may be disposed in an offset configuration relative to a central axis of the emitter tip 1804.

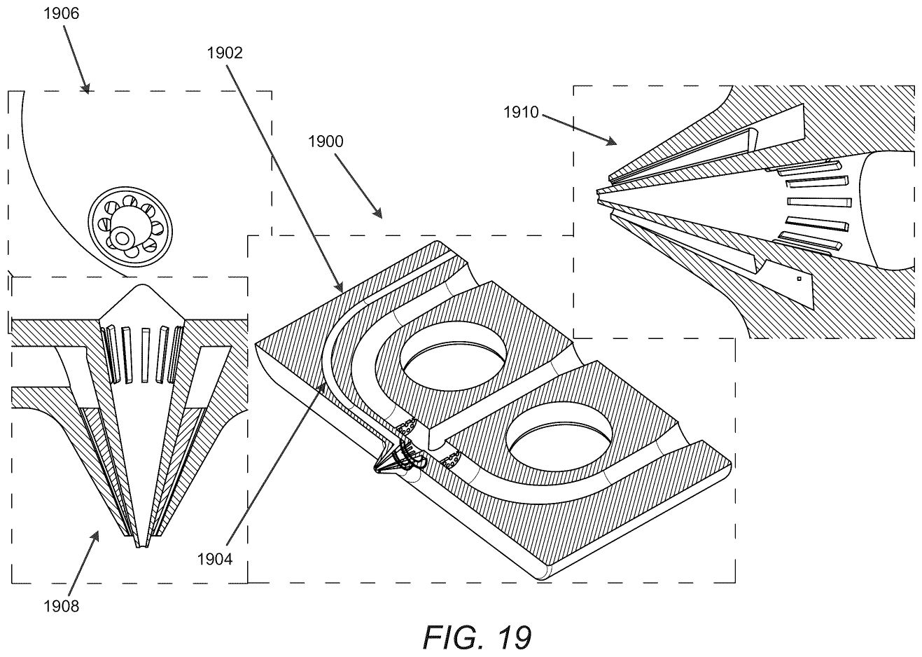

FIG. 19 illustrates a twelfth embodiment of a three-dimensional printed nanospray interface including a sheath gas to assist in spray formation, in accordance with an example of the present disclosure.

Referring to FIG. 19, emitter 1900 may include an emitter tip body 1902 including a discreetly routed fluid passage 1904 to cool the emitter tip body 1902. For example, the emitter 1900 may be internally cooled as shown. In this regard, a gas flow via fluid passage 1904 may cool the emitter tip body 1902 to provide thermal stability. An isometric view of the emitter 1900 is shown at 1906, and cutout views of the emitter 1900 are shown at 1908 and 1910.

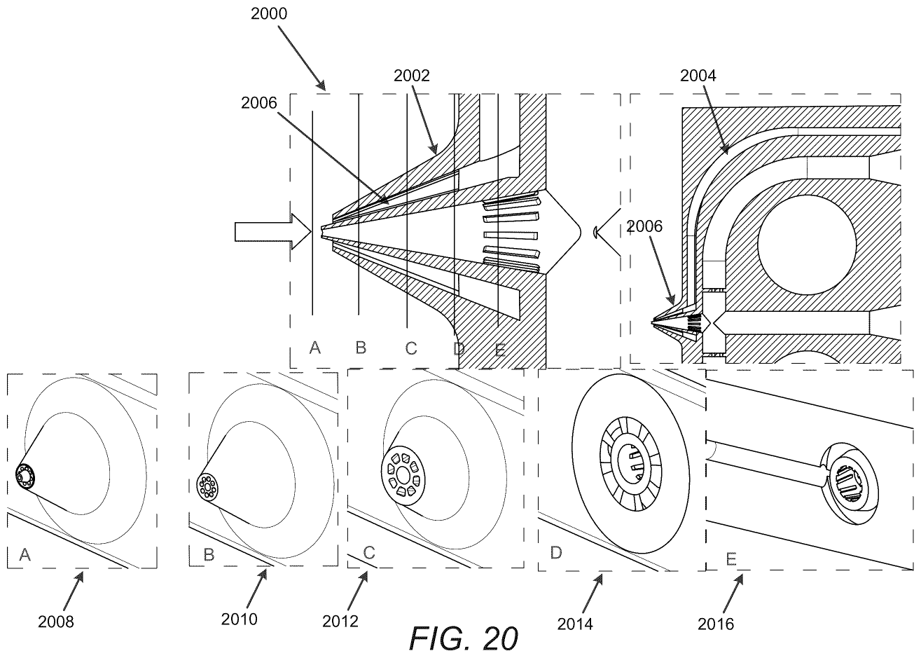

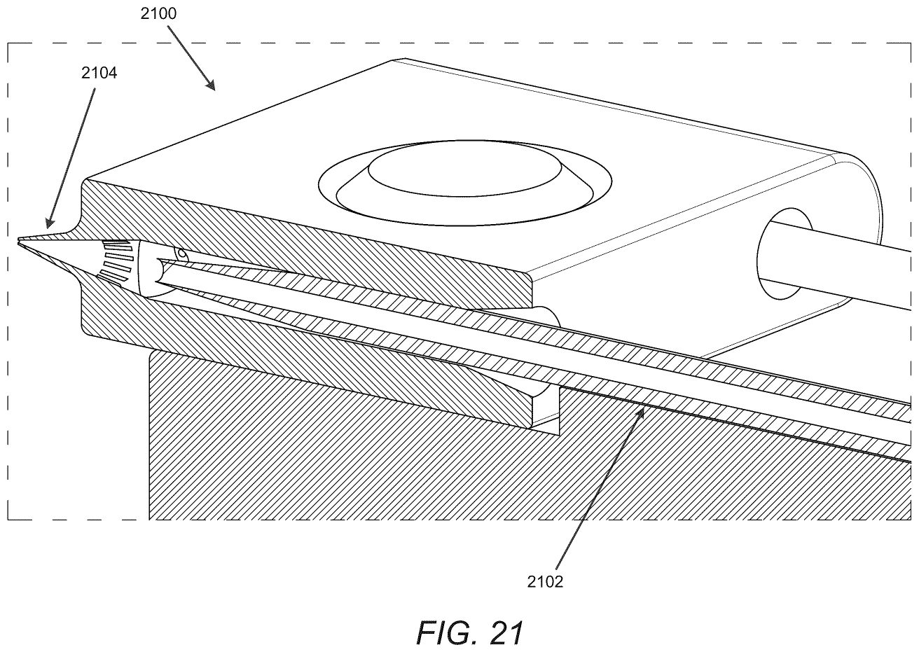

FIG. 20 illustrates a thirteenth embodiment of a three-dimensional printed nanospray interface including tip section views and sheath gas integrated into nanospray tip geometry, in accordance with an example of the present disclosure.

Referring to FIG. 20, emitter 2000 may include an emitter body 2002 including a discreetly routed gas passage 2004 to provide a sheath gas supply. In this regard, as shown at 2006, the sheath gas for emitter 2000 may be integrated into the tip geometry. For example, a straight gas flow is shown at 2006. However, vortex, helical, and other types of patterns may also be implemented. Cutout views taken along lines A, B, C, D, and E are shown respectively at 2008, 2010, 2012, 2014, and 2016.

FIG. 21 illustrates further details applicable to embodiments such as the eighth embodiment of the three-dimensional printed nanospray interface of FIG. 15, the thirteenth embodiment of the three-dimensional printed nanospray interface of FIG. 20, and other embodiments, in accordance with an example of the present disclosure.

Referring to FIG. 21, in a similar manner as disclosed herein with respect to FIG. 7, the nanospray interfaces 2100 may include a capillary (not shown) connected to a sheath inlet and a sheath outlet. The capillary may include a separation capillary. A tapered capillary tubing 2102 may be disposed in the capillary. The tapered capillary tubing 2102 may be axially movable within the capillary to control passage of analyte to emitter 2104. For example, the capillary tubing 2102 may be retracted in a direction away from the emitter 2104 to bypass the analyte through the emitter 2104, and moved in an opposite direction towards the emitter 2104 to direct the analyte to the emitter 2104.

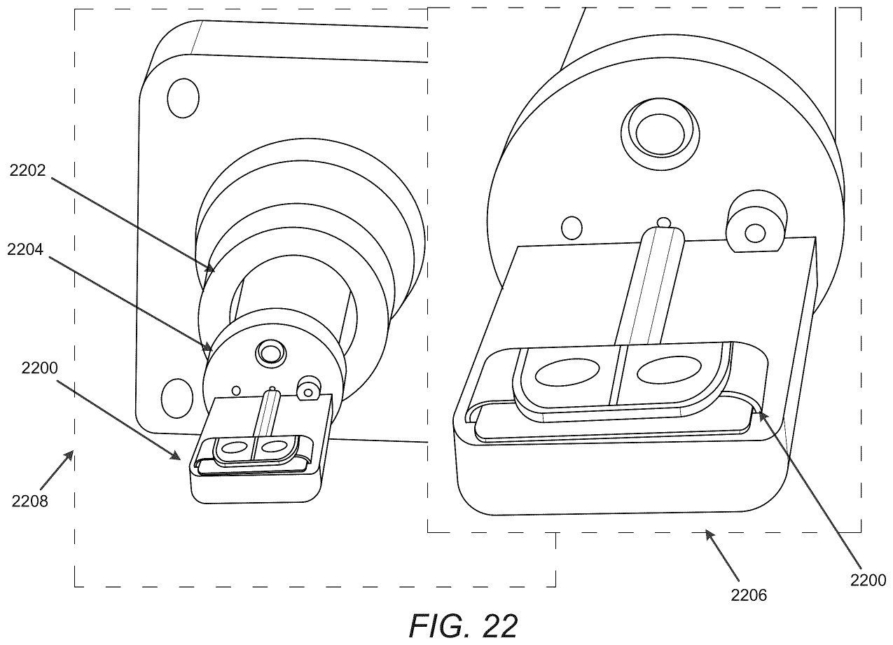

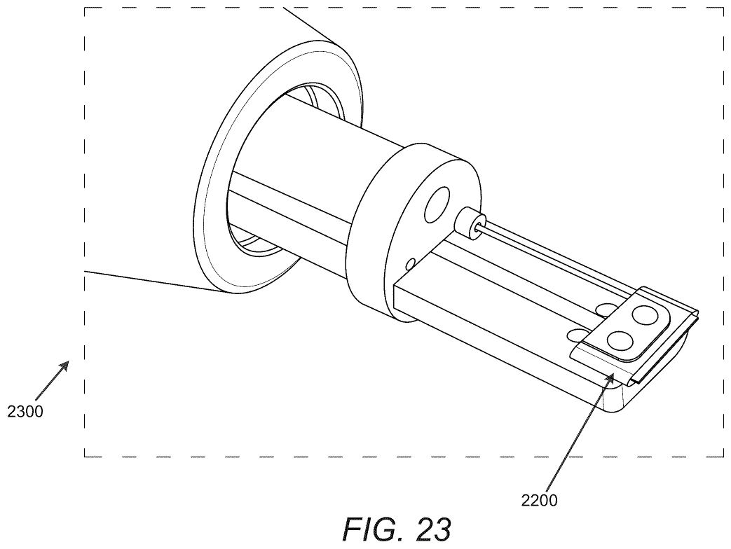

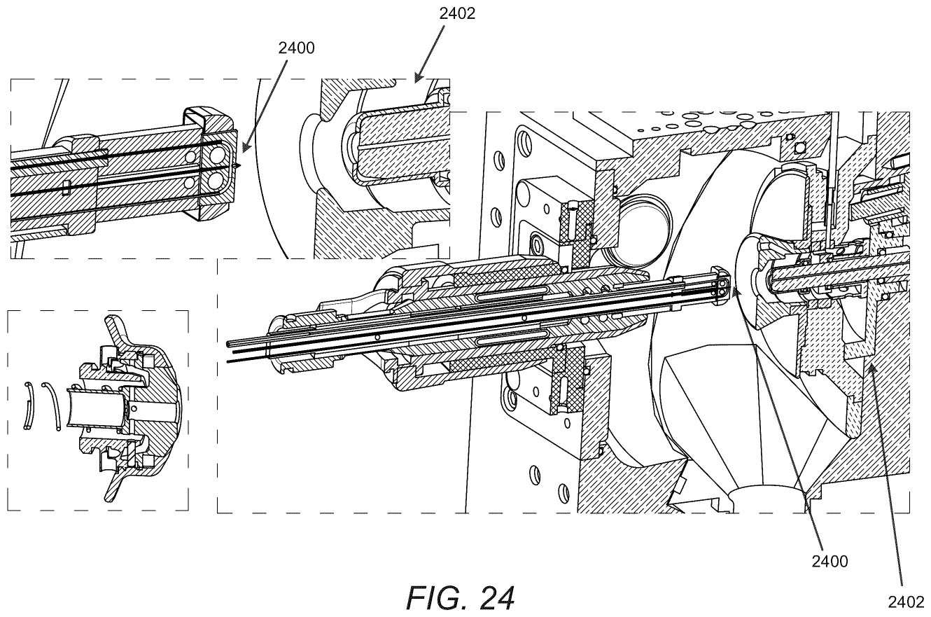

FIGS. 22 and 23 illustrate examples of an installation of a three-dimensional printed nanospray interface, in accordance with an example of the present disclosure.

Referring to FIGS. 22 and 23, examples of installation of a three-dimensional printed nanospray interface 2200 (similar to nanospray interface 200) are shown. As shown, the nanospray interface 2200 may be installed onto a holder 2202 (similar to holder 300), where the holder 2202 may include an interface mount 2204. The interface mount 2204 may include orifices for sheath inlet, sheath outlet, and a tapered capillary tubing. The view at 2206 represents an enlarged view of the nanospray interface 2200 shown at 2208. The view at 2300 (FIG. 23) represents an isometric view of the nanospray interface 2200 taken from another angle. The holder 2202 may be part of a nanospray-MS assembly (not shown).

FIG. 24 illustrates various isometric and cutout views of a chip holder for a three-dimensional printed nanospray interface, in accordance with an example of the present disclosure.

Referring to FIG. 24, FIG. 24 illustrates various isometric and cutout views of an emitter tip 2400 integrated into a source of a mass spectrometer 2402, where the orientation is in the view of a camera to make the ESI cone visible to a user. The setup of FIG. 24 is shown in a proportional ratio and distance that may be used in nanospray setups.

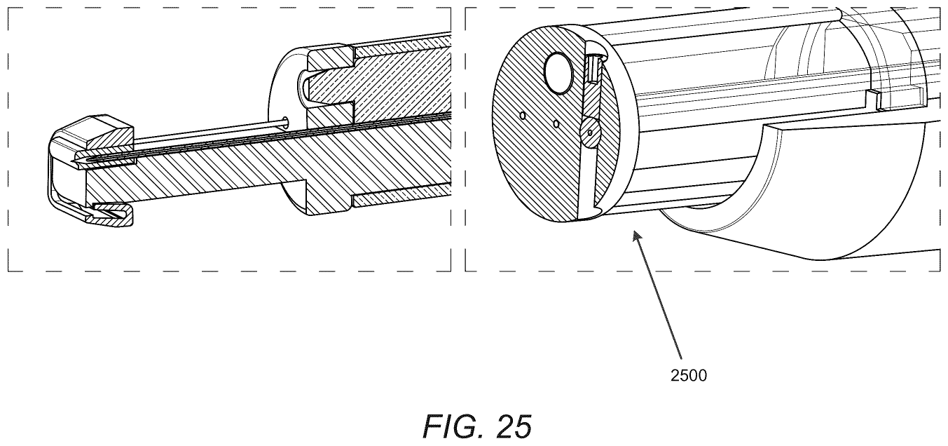

FIG. 25 illustrates various isometric and cutout views of a tip integrated into a three-dimensional printed nanospray interface, in accordance with an example of the present disclosure.

Referring to FIG. 25, FIG. 25 illustrates a grounding assembly of holder 2500 and a three-dimensional printed nanospray chip.

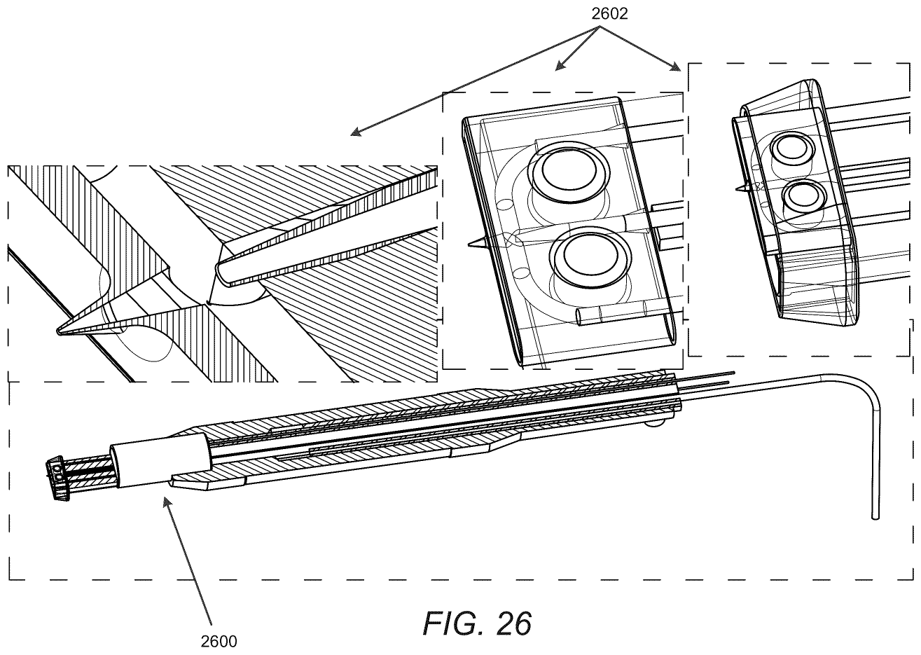

FIG. 26 illustrates an assembly and views of emitter tip geometry for a three-dimensional printed nanospray interface, in accordance with an example of the present disclosure.

Referring to FIG. 26, FIG. 26 illustrates a grounding capillary contacting (e.g., at 2600) a source housing. Further, FIG. 26 illustrates a full assembly 2602 of a holder and clamshell with a three-dimensional printed nanospray chip with sheath liquid channels and a delivery capillary. The sample delivery capillary is shown in a MS bypass state.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A three-dimensional printed nanospray interface for mass spectrometry, the nanospray interface comprising:
a body including a sheath inlet connected to a sheath outlet for passage of sheath liquid to an emitter,
wherein the emitter includes a sidewall including a stepped texture on an inner surface of the sidewall.

2. The three-dimensional printed nanospray interface according to claim 1, wherein the sheath inlet and the sheath outlet are formed in a generally U-shaped configuration.

3. The three-dimensional printed nanospray interface according to claim 1, further comprising:
a capillary connected to the sheath inlet and the sheath outlet; and
a tapered capillary tubing disposed in the capillary.

4. The three-dimensional printed nanospray interface according to claim 3, wherein the tapered capillary tubing is axially movable within the capillary to control passage of analyte through the emitter.

5. The three-dimensional printed nanospray interface according to claim 1, wherein the emitter includes an angled passage leading to an emitter tip, wherein the angled passage is configured to prevent sheath liquid backflow.

6. The three-dimensional printed nanospray interface according to claim 5, wherein the sidewall includes a tapered wall thickness in a direction towards an emitter tip.

7. The three-dimensional printed nanospray interface according to claim 1, wherein the emitter includes an emitter tip including a chevron configuration defined by a plurality of angled protrusions.

8. The three-dimensional printed nanospray interface according to claim 1, wherein the emitter includes an emitter tip and a flowback edge disposed adjacent to the emitter tip.

9. The three-dimensional printed nanospray interface according to claim 1, wherein the emitter includes an emitter tip and a plurality of V-shaped protrusions disposed on a surface of the emitter tip.

10. The three-dimensional printed nanospray interface according to claim 1, wherein the emitter includes an emitter tip body including a discreetly routed fluid passage to cool the emitter tip body.

11. A three-dimensional printed nanospray interface for mass spectrometry, the nanospray interface comprising:
a body including a sheath inlet connected to a sheath outlet for passage of sheath liquid to an emitter,
wherein the sheath inlet and the sheath outlet are formed in a generally U-shaped configuration.

12. The three-dimensional printed nanospray interface according to claim 11, wherein the emitter includes a sidewall including a stepped texture on an inner surface of the sidewall.

13. The three-dimensional printed nanospray interface according to claim 11, further comprising:
a capillary connected to the sheath inlet and the sheath outlet; and
a tapered capillary tubing disposed in the capillary.

14. The three-dimensional printed nanospray interface according to claim 11, further comprising:
an internal passage including micromembrane structures to capture column beads and debris.

15. The three-dimensional printed nanospray interface according to claim 11, further comprising:
a plurality of flow straighteners to guide a flow of the sheath liquid and reduce wear.

16. A three-dimensional printed nanospray interface for mass spectrometry, the nanospray interface comprising:
a body including a sheath inlet connected to a sheath outlet for passage of sheath liquid to an emitter,
wherein the emitter includes an emitter tip, and
wherein the emitter tip:
is offset from a central axis of the nanospray interface;
includes a non-circular configuration; or
includes a plurality of V-shaped protrusions disposed on a surface of the emitter tip.

17. The three-dimensional printed nanospray interface according to claim 16, further comprising:
a capillary connected to the sheath inlet and the sheath outlet; and
a tapered capillary tubing disposed in the capillary.

18. The three-dimensional printed nanospray interface according to claim 17, wherein the tapered capillary tubing is axially movable within the capillary to control passage of analyte through the emitter.

19. The three-dimensional printed nanospray interface according to claim 16, wherein the emitter includes a flowback edge disposed adjacent to the emitter tip.

20. The three-dimensional printed nanospray interface according to claim 16, wherein the emitter includes a light source angled relative to the emitter tip exit to make visible passage of analyte through the emitter.
